(19) United States
(12) Patent Application Publication
(10) Pub. No.: US 2012/0173336 A1
(43) Pub. Date: Jul. 5, 2012

(54) METHOD AND SYSTEM FOR PROMOTING HEALTH AWARENESS IN A VEHICLE

(75) Inventor: Gary Steven Strumolo, Beverly Hills, MI (US)

(73) Assignee: FORD GLOBAL TECHNOLOGIES, LLC, Dearborn, MI (US)

(21) Appl. No.: 12/981,719

(22) Filed: Dec. 30, 2010

(51) Int. Cl. G06Q 30/00

(52) U.S. Cl. 705/14.53; 705/14.58

(57) ABSTRACT

One or more embodiments may include a method and system for providing health information in a vehicle. Geographic location information for a vehicle may be received at a vehicle computer. Additionally, health information for one or more vehicle occupants may be received at the vehicle computer. Based on the geographic location information, one or more dining establishments may be identified. Menu item information, including the nutritional information for the menu items, for the dining establishment(s) may be received. Based on the health information for the vehicle occupant(s), the menu item information, and the nutritional information for the menu items, dining suggestions may be presented at the vehicle computer.

### BACKGROUND

1. Technical Field

Various embodiments relate to providing healthy dining options and/or alternatives to an occupant in a vehicle. In some embodiments, the dining options/alternatives may be in and/or around the geographic location of the vehicle. In some embodiments, the dining options/alternatives may be based on a health condition of the vehicle occupant.

2. Background Art

Restaurants, and in particular fast-food establishments, are encouraged by the government and health professionals to provide nutritional information for items offered by the establishment. The nutrition information is generally displayed at the establishment in plain view of the customers and/or, if the establishment has an online presence, on a website. Additionally, some third-party websites also provide nutritional information.

There are various examples of methodologies and systems available that provide nutritional information to a user for a food order and/or menu items at an establishment. One such example is U.S. Pat. No. 7,680,690 to Catalano (“'690 patent”). The '690 patent discloses a methodology for customers seeking to purchase a meal from a food service vendor such as a restaurant, a cafeteria, or a vending machine, by ordering a food preparation based upon menu-selections. In addition to receiving ordered food, customers receive suggestions for optionally modifying their food orders based upon nutritional benefits and other criteria. Either during real-time customer-ordering or during post-ordering, a food-service vendor presents a customer suggestions specific to a pending tentative or completed order, wherein the customer may enjoy purported nutritional benefits by electing to follow these suggestions and thereby modify the tentative order into a corresponding completed order. Alternatively, the customer may elect to ignore these suggestions, but may nonetheless decide to effect such food-ordering modifications during subsequent visits. The food selection criteria implemented by a food service vendor is independent of individual customer identity and preferences, and are flexible and readily adaptable to accommodate changes such as a food service vendor's marketing strategy, customer-food preferences, discoveries pertaining to nutrition and consequent good health; and may be adapted to a plethora of food service environments. Also discloses is a restaurant environment in which customers typically approach a food-ordering counter and interface with both a menu display and with order-taking personnel. Also disclosed is the use of kiosks, vending machines, remote access devices, and locally and remotely-accessed networked computers, wherein customers interact with automated computer-driven devices instead of or in addition to wait-staff or other food service personnel.

### SUMMARY

In one aspect, a computer-implemented method for providing health information in a vehicle includes receiving at a vehicle computer geographic location information of a vehicle. Additionally, health information for one or more vehicle occupants may be received at the vehicle computer. One or more dining establishments may be identified based on the geographic location of the vehicle. Menu item information for the dining establishment including the nutritional information for the menu items may be received at the vehicle computer. Accordingly, dining suggestions based on the health information, the menu item information, and the nutritional information for the menu items may be presented at the vehicle computer.

In another aspect, a system for providing health information in a vehicle may include a vehicle computer configured to receive geographic location information of a vehicle and, additionally, to receive a meal order history for one or more vehicle occupants. The vehicle computer may be further configured to determine a location of one or more dining establishments based on the geographic location of the vehicle. One or more of the dining establishments based on the location of the dining establishment and the geographic location of the vehicle may be selected to receive information pertaining to menu items of the dining establishment including nutritional information for the menu items. Further, the vehicle computer may be configured to receive the menu item information including nutritional information for the menu item. A meal order may be received and, based on the meal order history, the meal order, the menu item information, and the nutritional information for the menu items meal alternative may be presented.

In another aspect, a system includes a vehicle computer configured to receive information indicating that a vehicle is en route to a destination and information defining dining venues along the route. The vehicle computer may also be configured to receive a vehicle occupant's health information and information defining the dining venue's menu items including nutritional information. Based on the health information, the menu items, and the nutritional information, dining suggestions may be presented.

These and other aspects will be better understood in view of the attached drawings and following detailed description of the invention.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 is a block diagram of a vehicle-based computing system;

FIG. 2 is an operation according to one embodiment for providing dining and/or meal information to a vehicle occupant when the occupant is not at the dining establishment;

FIG. 3 is an operation according to one embodiment for presentation of nutritional and meal information when the vehicle occupant is at the dining establishment; and

FIG. 4 is an operation according to one embodiment for providing alternative dining options to a vehicle occupant.

### DETAILED DESCRIPTION

For customers on the go, it is sometimes difficult to make proper choices with respect to diet, especially when in transit. Typically, data such as restaurant nutrition information that is available to a mobile user is from a mobile application. However, these mobile applications may provide more general nutritional and health information rather than providing meal and dining options that are specific to a person's health needs. Further, these mobile applications may not provide healthy dining options specific to the vehicle occupant's health needs that are in the geographic vicinity of the vehicle. Further, these mobile applications may not communicate with components such as navigation systems and wellness devices in the vehicle.

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

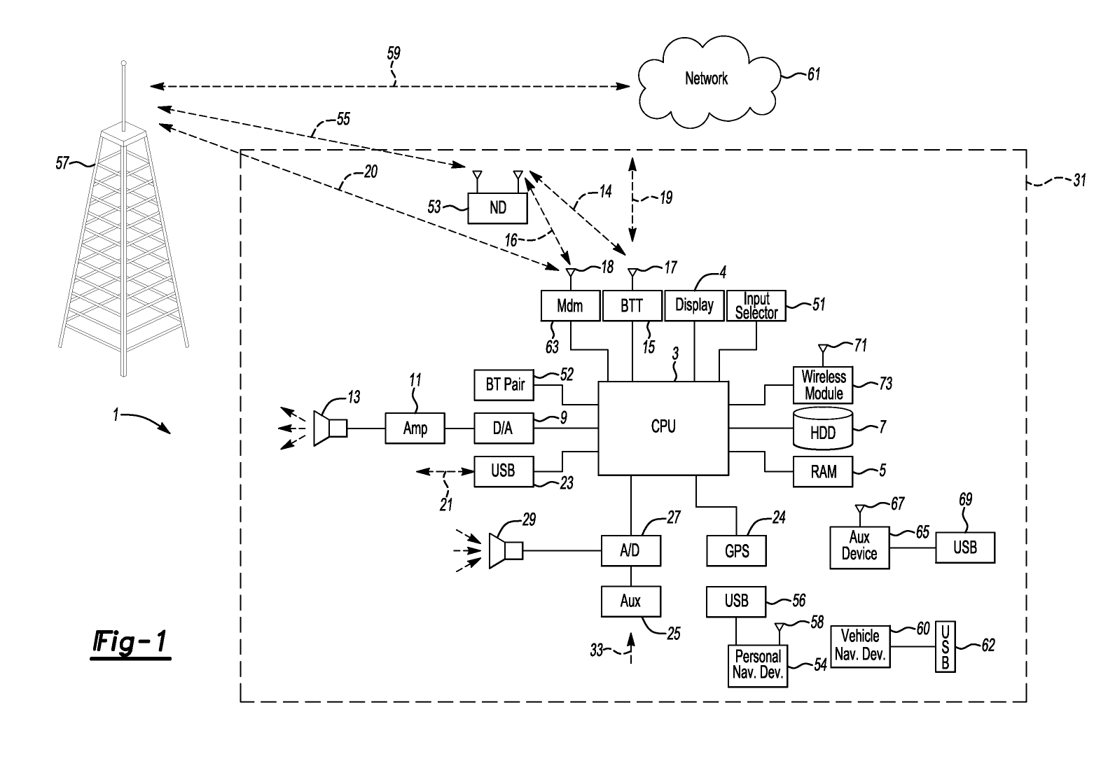

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS 1 may use a vehicle network (such as, but not limited to, a CAN bus) to pass data to and from the VCS 1 (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

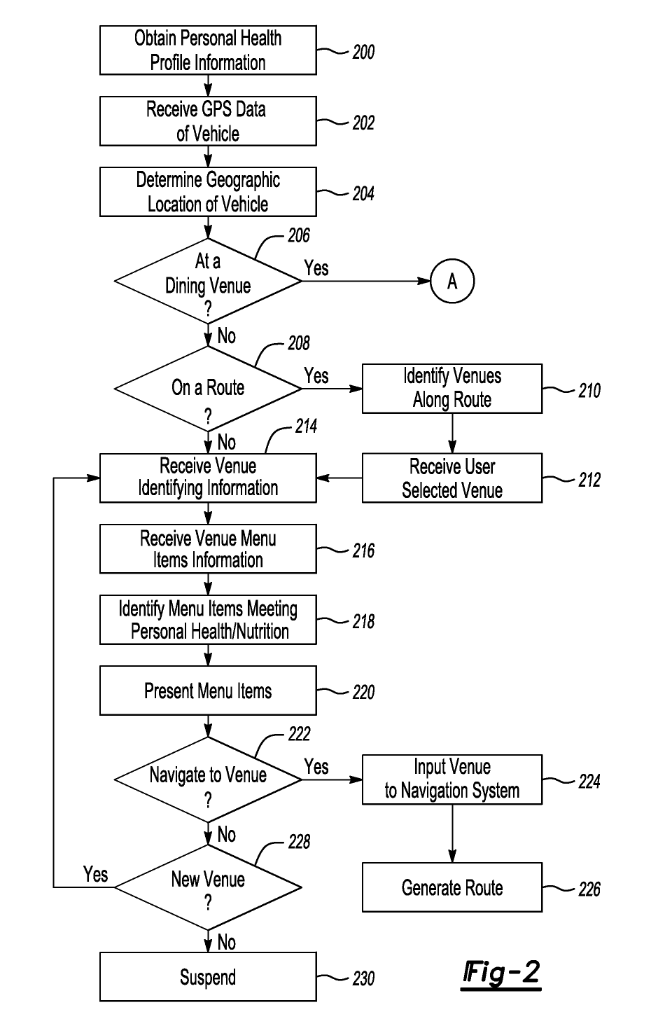

There may be multiple scenarios in which a vehicle occupant may receive dining and/or meal information in a vehicle. As one non-limiting example, the information may be received in a location remote from the dining establishment such as at the vehicle occupant's home, office, school, or other like remote locations. As another non-limiting example, the information may be received while the vehicle is en route to a destination. As yet another non-limiting example, the dining and/or meal information may be received when the vehicle is at the dining establishment. FIG. 2 illustrates a process for providing dining and/or meal information (referred to generally as “health awareness information”) to a vehicle occupant when the vehicle is not at the dining establishment. As illustrated in FIG. 2, the vehicle may or may not be en route to a particular destination. It will be appreciated that the arrangement of FIG. 2 may be modified and rearranged according to the needs of a particular implementation without departing from the scope of the invention.

An application may be programmed to provide health awareness information to a vehicle occupant. This application may be developed by the OEM or a third-party and stored on the VCS 1, the ND 53 and/or on a remote server communicating with the VCS 1 via a network connection (such as, and without limitation, the Internet) 61. Alternatively or additionally, the VCS 1 may include programmed circuitry for providing health awareness information. In all cases, the VCS 1 may communicate with one or more systems (not shown) via network 61 storing information such as, and without limitation, nutritional information, publicly available health information, menu items offered at a dining establishment, and personal health profiles of the vehicle occupant(s). Other non-limiting information that may be obtained will be described in further detail below.

Health awareness information may be provided in the vehicle once the application is active and running. The application may be activated by a vehicle occupant using voice and/or tactile commands. Alternatively or additionally, the presentation of health awareness information may be trigged by a point of interest search on the navigation system 54, 60. In yet additional or alternative embodiments, the presentation of health awareness information may be trigged when the GPS coordinates of the vehicle obtained by the GPS system 24 indicates that the vehicle is at a dining establishment.

In some embodiments, the health awareness information may be provided to the user when the user requests such information. For example, and without limitation, the information may be provided to the user when the POI is selected and in response to a tactile and/or audible command requesting the health awareness information for the POI.

User(s) of a vehicle may have personal health and nutritional information stored in a health profile associated with each user of the vehicle. This health profile may include health conditions and medical history of the vehicle user(s) such as diabetes, high blood pressure, high cholesterol, obesity, and the like. The information may be input into the profile by the vehicle user(s) and/or individuals authorized to do so, such as a primary care doctor or a family member.

In some embodiments, the profile may be linked to an electronic medical record system storing the vehicle user(s) medical history. Accordingly, the profile may be updated automatically when the user's electronic medical record is updated. Of course, the vehicle user(s) provides authorization for access to the electronic medical records. Further, the information may be associated with a security feature (such as data encryption) for user and data privacy. Further, the information may comply with all patient confidentiality regulations and laws (including, but not limited to, Health Insurance Portability and Accountability Act (HIPAA)).

The health profile may also include a personal health regimen submitted by the user(s) regardless of whether or not the vehicle user(s) have a health condition. For example, and without limitation, the personal health regimen may include a dietary regimen to lose weight or for a pregnancy. It may also include a training regimen, for example, for a vehicle occupant who is training for an athletic event such as a marathon. In such cases, the vehicle user(s) may provide a personalized personal health regimen. Additionally or alternatively, the personal health regimen may be based on general recommendations available to the public (e.g., via the Internet).

Referring now to FIG. 2, personal health profile information may be received in the vehicle (block 200). The personal health profile information may be identified and received based on user identification input at the vehicle including, but not limited to, a mobile identification number (MIN), username and password, voice recognition, a user-specific code, or a combination of identification schemes.

The geographic location of the vehicle may be used in determining what dining options are available to a vehicle occupant. Various parameters relative to the vehicle's location may be used to search for and locate the dining options such as, and without limitation, distance. Based on GPS data received in the vehicle (block 202), the geographic location of the vehicle may be determined (block 204).

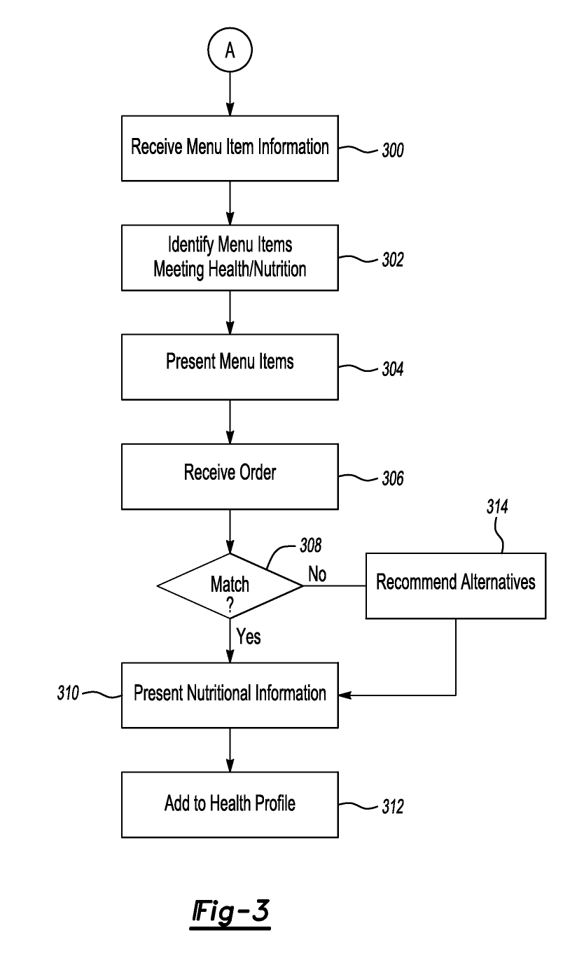

It may also be determined if the vehicle is at a dining venue (block 206). If so, the process may continue as illustrated in FIG. 3 and represented by circle block A in FIG. 2. FIG. 3 will be further described in detail below.

If the vehicle is not at a dining venue, it may be determined if the vehicle is en route to a destination (block 208). If so, the dining establishments along the route may be identified (block 210). In some embodiments, the identified POIs may be venues along the route that include at least one menu item that satisfies the personal health information, or rules, defined in the personal health profile. In some embodiments, the presentation of the POIs may be ordered based on the number of menu items at the POI (e.g., dining establishment) that satisfy the personal health rules (e.g., in ascending or descending order). The POIs may or may not be limited by a geographic boundary (e.g., and without limitation, POIs within a 10 mile radius). The geographic boundary may be user-defined and/or OEM defined.

When the user has identified a venue, the user selection may be received by the VCS 1 (block 212).

Information identifying the dining venue may be received by the VCS 1 (block 214). The venue identifying information may alternatively be received if the vehicle is not on a route (block 208) as shown in the non-limiting operation illustrated in FIG. 2. As a non-limiting example, the user may set a dining establishment as a destination before starting a journey in the vehicle.

Venue identifying information may include, but is not limited to, a name, address, URL, and/or telephone number of the venue. The menu items offered at the dining venue and information associated with the menu items may be received (block 216). A partnership between one or more dining venues and the OEM may be entered into in order to make available menu items and information to vehicle occupants. The menu items and information may be locally or remotely stored and managed by the OEM and/or the dining venue partner. Accordingly, one or more data packets including venue identifying information may be locally (e.g., at the vehicle computer) or remotely exchanged to identify and obtain the available menu items and the information associated with the menu items.

The menu items that are offered at the dining venue may be compared to the information in the personal health profile of the vehicle user. Using the information associated with the menu items, such as (and without limitation) nutritional information and/or the ingredients of the menu items, those items or combination of items that satisfy (or closely satisfy) information provided in the personal health profile may be identified (block 218). As an example, if the vehicle occupant is a diabetic, menu items and/or a combination of menu items may be identified and suggested that are low in sugar. As another example, if the vehicle occupant suffers from hypotension (i.e., low blood pressure), a combination of menu items that comprise a low carbohydrate diet may be suggested. As another example, if the vehicle occupant is following a personal health regimen, such as a training regimen for running a marathon, the items identified may be suitable for such training. As yet another example, menu items may be identified that are suitable for a pregnant woman to ensure the health of the woman and the baby. The items may or may not be based on a personalized regimen stored with the profile. Of course, these examples are non-limiting and a plethora of other scenarios may be possible.

The identified menu items may be presented to the vehicle occupant(s) (block 220). The items may be presented on display 4 and/or audibly through speaker 13 (e.g., in a spoken language). In some embodiments, the user may be presented with all the menu items with a clear identification of the menu items satisfying the personal health profile.

Whether or not the vehicle is en route to a particular destination, the vehicle occupant(s) may or may not desire to visit the dining establishment. The user may be presented with an option to be navigated to the dining establishment. If the user desires to be navigated to the venue (e.g., identified by a tactile and/or audible input) (block 222), the venue may be input as a destination or waypoint to the navigation system (block 224). The route to the dining venue may be generated (block 226) and presented in the vehicle for navigation to the dining venue.

Certainly, the vehicle occupant may not desire any of the menu items presented or the occupant's meal plans may change. In such a case, the user may not desire to be navigated to the dining establishment (e.g., identified by a tactile and/or audible input) (block 222).

In some embodiments, the user may be given a further option to select a new dining venue (block 228). If the user would like to be presented with additional venue options (e.g., identified via a tactile and/or audible input), the non-limiting menu item identification process described above may be repeated. In some embodiments, other venues having menu items satisfying the personal health profile rules may be presented for selection by the vehicle occupant. Otherwise, the operation may be suspended (block 230).

Referring back to block 206 of FIG. 2, when the vehicle is at a dining venue, the vehicle occupant may additionally be presented with meal options and/or alternatives (circle block A). This process is illustrated in FIG. 3. It will be appreciated that the disclosure and arrangement of FIG. 3 may be modified or re-arranged to best fit a particular implementation of the various embodiments of the invention.

The menu items offered at the dining venue and information associated with the menu items may be received (block 300). Using the information associated with the menu items, such as (and without limitation) nutritional information and/or the ingredients of the menu items, those items or combination of items that satisfy information provided in the personal health profile may be identified (block 302).

The identified menu items may be presented to the vehicle occupant(s) (block 304). The items may be presented on display 4 and/or audibly through speaker 13 (e.g., in a spoken language). In some embodiments, the user may be presented with all the menu items with a clear identification of the menu items satisfying the personal health profile.

The vehicle occupant may present the desired meal order to an employee of the dining establishment. By the system identifying the vehicle at a dining establishment, the in-vehicle microphone 29 may be activated in order to listen for the order placed by the vehicle occupant (block 306). In some embodiments, a notification or reminder may be presented to the vehicle occupant to activate the microphone 29 (e.g., using a push-to-talk button in the vehicle). Certainly, it is not required that the microphone 29 listen for the order at the time of placing the order. The vehicle occupant may additionally or alternatively present the proposed order to the VCS 1 prior to presenting the order to the employee, for example, when waiting in a drive-thru line.

When the order is presented, a determination may be made at the VCS 1 whether a match exists between the order and the personal profile information (block 308). If so, the nutritional information for the order may be presented in the vehicle (block 310).

In some embodiments, the order may be added to the personal health profile (block 312). Using this profile information, the health awareness of the vehicle occupant may be tracked personally and/or by a medical professional.

If no match exists, alternative meal options may be recommended which may satisfy or closely satisfy the personal health rules defined in the personal health profile (block 314). The occupant may or may not select the alternative options presented. In either case, the nutritional information may be presented to the occupant (block 310) and the order added to the health profile (block 312).

As an alternative to, or in addition to, having a personal health profile, the vehicle occupant's health information may be received in the vehicle if it is outfitted with a personal health wellness device 67. The wellness device may monitor the occupant's health periodically and/or in response to a user request. A periodic notification may be presented to the occupant in the vehicle. The information collected from the wellness device may be stored locally in the vehicle and/or remotely from the vehicle. In some embodiments, some information may be collected from the wellness device and other information from the personal health profile.

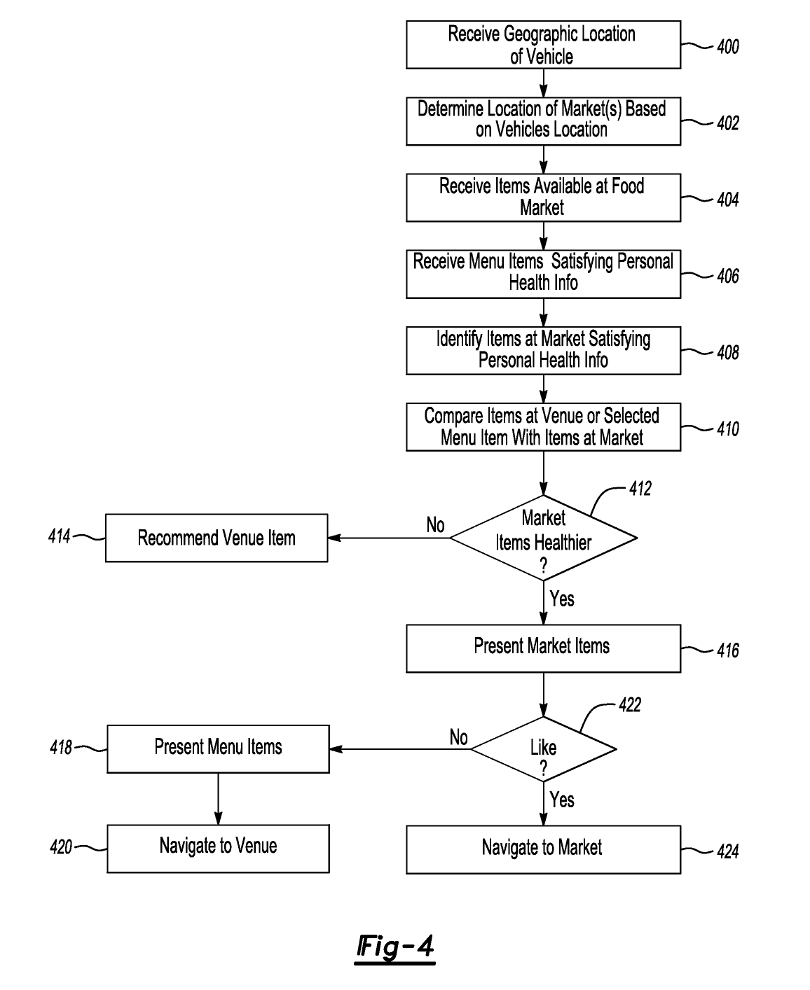

A vehicle occupant may be presented with, in some embodiments, meal options from other restaurants or venues other than restaurants. As one non-limiting example illustrated in FIG. 4, this other venue may be a food market. It will be appreciated that the disclosure and arrangement of FIG. 4 may be modified or re-arranged to best fit a particular implementation of the various embodiments of the invention. Certainly, it will be appreciated that the operation illustrated in FIG. 4 may be additionally or alternatively be used in identifying other dining venues that may provide healthier meal options.

These alternate options may be presented to a vehicle occupant regardless of the location of the vehicle and whether or not the vehicle is en route to destination. The geographic location of the vehicle may be received in a manner as described above (block 400). Further, the location of markets with respect to the location of the vehicle may be determined based on, for example, GPS data (block 402). In some embodiments, the identified food markets may be defined by a geographic boundary (e.g., and without limitation, within a predefined distance) which may be user-defined and/or OEM defined.

The market's inventory may be received by the VCS 1 (block 404). Typically, the market items may be prepared foods and pre-prepared foods (such as frozen and canned foods) offered at the market. The inventory information may be obtained via network 61 from a database (not shown) storing the market's inventory. This database may be operated by the market, the OEM, or collaboratively between the market and the OEM. In the case of dining venues, the menu items may be obtained as described above.

The items satisfying the personal health profile information may be determined from the menu items of the originally selected dining venue (block 406). The identification process for the menu items is described with respect to FIGS. 2 AND 3.

From the market's inventory, the market items that satisfy or closely satisfy the personal health profile rules may be identified (block 408). The market items and menu items may be compared to determine which establishment offers the better (e.g., healthier) alternative (block 410). The comparison may include, but is not limited to, a comparison of the nutritional information and/or ingredients of the market items and the menu items. Based on the comparison, a value may be associated with each item defining the “healthier” status of the item. The values may be numeric, alphabetic, or alphanumeric. As a simplified non-limiting example, the calories of the market item and the menu item may be compared. A value of “0” may be assigned to the less healthy item(s) (e.g., the item with the higher caloric intake) and a value of “1” to the healthier item(s) (e.g., the item with the less caloric intake). Certainly, the values identifying what is “healthier” and “not healthier” may be assigned in any manner without departing from the scope of the invention.

Accordingly, a determination may be made if the market item (or, more generally, the other venue's item) is healthier (block 412). If not, the menu item(s) is suggested to the occupant as a meal option (block 414).

If at least one market item is healthier, the identified market items may be presented to the occupant (block 416). In some embodiment, the market items may be presented as recommendations over the menu items.

The occupant may or may not like the market items presented. There may be multiple ways of identifying the user's preferences for the menu item or market item. For example, and without limitation, the preference may be identified based on a request to navigate to the market or the dining venue. As another non-limiting example, the user's order of a menu item at the dining establishment may indicate a preference for the menu item. As another non-limiting example, the user may be asked by the system if there is a preference for the menu item(s) or the market item(s).

If the user does not like the market items, which may be identified based on input from the occupant, then the venue items may be presented (block 418). Otherwise, the market items may be presented. In some embodiments, the vehicle occupant may present a preference by requesting to be navigated to the venue or the market. The request may be made tactically and/or audibly. Accordingly, the destination may be set as the dining venue (block 420) or the market (block 422).

Health awareness information may be provided at any time. In some embodiments, the information may be provided based on the type of meal and/or time of day. For example, and without limitation, based on a time of day, it may be determined whether the food item is a snack or a meal. The time of day may be determined based on when the POI search is performed or the arrival time at a dining venue. In some embodiments, each meal type may be associated with a time range. For example, and without limitation, if the time is between 11 AM and 1 PM, the meal type may be considered a full lunch and, accordingly, information on lunch size portions may be provided. At odd times (e.g., at 3 PM), the user may be recommended to eat a snack and the health awareness information accordingly provided.

In some embodiments, health awareness information may be provided based on the vehicle occupant's meal order history. The history may be stored in the health profile. Some vehicle occupants, however, may not create a health profile. In these instances, health awareness information based on meal order history may be particularly useful. The meal order history of one or more vehicle occupants may be stored in VCS memory and retrieved based on one or more of the non-limiting user identifiers described above. Additionally or alternatively, the meal order history may be stored on a key fob. The history may be defined by a limited period of time (e.g., and without limitation, based on days, weeks, months, and the like).

When an order is being placed, the VCS 1 may receive the order and retrieve the occupant's meal order history, which may be performed simultaneously or non-simultaneously. Based on the order history, information may be extracted from the history to determine whether an alternative meal option should be recommended to the vehicle occupant. Such information may relate to (without limitation) caloric intake, fat and trans-fat intake, cholesterol intake, sugar intake, fiber intake, protein intake, and the like. As a non-limiting example, if the history shows that the occupant has consumed meals high in calories, an order with lower calories may be suggested. As another non-limiting example, if the order history indicates that the occupant has had little protein, an order with protein may be suggested.

There may be instances when a user does not search for a dining venue or may not order a meal while in a vehicle. Accordingly, in some embodiments, the vehicle occupant may provide an update on meal consumption. The update may be provided, for example, after a certain period of time has elapsed between system uses. This period of time may be defined by the OEM and/or the user.

The updates may be stored in the health profile. When providing an update, the vehicle occupant may or may not provide specific meal descriptions. As a non-limiting example of a more general update, the vehicle occupant may update the profile by indicating that seafood was consumed within the week. Accordingly, if the vehicle occupant is a pregnant woman, such information may be used to provide meal options that do not include seafood or particular types of seafood. As a non-limiting example of a more specific update, meal options for a vehicle occupant with high cholesterol may not include beef if the vehicle occupant indicates that steak was recently consumed. Of course, these examples are for illustration purposes and the generality or specificity of the meal descriptions may vary in implementation without departing from the scope of the various embodiments of the invention.

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

What is claimed:

1. A computer-implemented method for providing health information in a vehicle, the computer-implemented method comprising:
receiving at a vehicle computer geographic location information of a vehicle;
receiving at the vehicle computer health information for one or more vehicle occupants;
identifying one or more dining establishments based on the geographic location of the vehicle from which to receive information pertaining to menu items of the dining establishment including nutritional information for the menu items;
receiving at the vehicle computer the menu item information including the nutritional information for the menu items; and
presenting at the vehicle computer dining suggestions based on the health information, the menu item information, and the nutritional information for the menu items.

2. The computer-implemented method of claim 1 wherein the dining suggestions include at least one of one or more alternative dining establishments or one or more food markets.

3. The computer-implemented method of claim 1 further comprising receiving information at the vehicle computer identifying a meal selection, wherein the dining suggestions include one or more alternatives for the meal selection.

4. The computer-implemented method of claim 1 further comprising determining that the vehicle is en route to a destination based on the geographic location information.

5. The computer-implemented method of claim 4 wherein the one or more dining establishments are on the destination route.

6. The computer-implemented method of claim 1 wherein the health information includes personal health information.

7. The computer-implemented method of claim 6 wherein presenting the dining suggestions includes ordering the dining suggestions based on a number of menu items that satisfy the personal health information.

8. The computer-implemented method of claim 1 wherein the health information includes a dietary regimen or a training regimen for one or more vehicle occupants.

9. The computer-implemented method of claim 1 wherein the health information includes one or more health conditions of one or more vehicle occupants.

10. The computer-implemented method of claim 1 further comprising receiving at the vehicle computer a user input defining a point of interest search request for identifying the one or more dining establishments.

11. A system for providing health information in a vehicle, the system comprising:
a vehicle computer configured to:
receive geographic location information of a vehicle;
receive a meal order history for one or more vehicle occupants;
determine a location of one or more dining establishments based on the geographic location of the vehicle;
select one or more of the dining establishments based on the location of the dining establishment and the geographic location of the vehicle to receive information pertaining to menu items of the dining establishment including nutritional information for the menu items;
receive the menu item information including nutritional information for the menu items;
receive a meal order; and
present meal alternatives based on the meal order history, the meal order, the menu item information, and the nutritional information for the menu items.

12. The system of claim 11 wherein the vehicle computer is further configured to store the meal order history.

13. The system of claim 11 wherein the vehicle computer is further configured to associate a vehicle occupant identifier with the meal order history.

14. The system of claim 11 wherein the vehicle computer is further configured to present meal alternatives from vehicle speakers, a vehicle display or both.

15. The system of claim 11 further comprising a vehicle microphone for receiving the meal order.

16. The system of claim 15 wherein the vehicle computer is further configured to identify the vehicle as located at the one or more dining establishments.

17. The system of claim 16 wherein the vehicle computer is further configured to, upon identifying the vehicle as located at the one or more dining establishments, activate the microphone for receiving the meal order.

18. The system of claim 11 further comprising a health wellness device configured to receive a health condition of one or more vehicle occupants.

19. A system comprising:
a vehicle computer configured to:
receive information indicating that a vehicle is en route to a destination and information defining dining venues along the route;
receive a vehicle occupant's health information and information defining the dining venue's menu items including nutritional information; and
present dining suggestions based on the health information, the menu items, and the nutritional information.

20. The system of claim 19 wherein the vehicle computer is further configured to:
receive time information; and
suggest a meal type to a vehicle occupant based on the time information.

21. The system of claim 20 wherein the vehicle computer is further configured to present dining suggestions based on the meal type.
